(19) United States
(12) Patent Application Publication
(10) Pub. No.: US 2025/0316134 A1
(43) Pub. Date: Oct. 9, 2025

(54) INTEGRATED COMPUTERIZED PLATFORM FOR SPORTS GAMBLING

(71) Applicant: Kitty Gaming, Inc., Quincy, MA (US)

(72) Inventor: Stephen Vaccaro, Quincy, MA (US)

(21) Appl. No.: 18/910,562

(22) Filed: Oct. 9, 2024

Related U.S. Application Data
(63) Continuation-in-part of application No. 18/630,934, filed on Apr. 9, 2024.

(51) Int. Cl. G07F 17/32; G06N 20/00; G06Q 50/34

(52) U.S. Cl. CPC G07F 17/323; G06N 20/00; G06Q 50/34; G07F 17/3239; G07F 17/3288

(57) ABSTRACT

The present disclosure teaches an integrated computerized platform for sports gambling. First, a plurality of legal operators for sports gambling are identified in a given state. The platform collects data from the operators and aggregates the collected data. The aggregated data is displayed to users of the platform, wherein the most favorable line provided by the plurality of operators for each of a plurality of events is highlighted. The platform has a platform account at each of the plurality of operators. When a user places a bet via the platform, targeting operator A, the platform deposits a payment from the user into the platform account A at operator A and places a bet via the platform account A. If the user wins the bet, operator A will issue a payback to the aggregated account A, and the platform will subsequently issue the payback to the user.

### TECHNICAL FIELD The present disclosure relates to computerized applications for sports gambling.

### BACKGROUND

With the legalization of sports gambling in many states of the U.S., there are now about ten to fifteen operators granted licenses in each state. For the same bet, each operator may have a slightly different “payout”, “odds”, or “line”. Therefore, it is beneficial for a gambler to “shop around” because one of the operators may give the gambler the best risk/reward balance. Nevertheless, shopping around can be expensive and troublesome. A gambler needs to open an account at each of the ten to fifteen operators available in the state (and sometimes would be required to store a given amount of money in each account) and look through all the ten to fifteen operators to find the best operator to place a bet with. Opening and maintaining an account electronically could be a troublesome and expensive process, and so is going through back and forth between different computer-based user interfaces to gather information and make comparisons. Finding the operator offering the most favorable odds and placing a bet with them could also be extra trouble.

Therefore, it would be helpful to introduce an integrated computerized platform for sports gambling on which a gambler can (1) for a given sports event, electronically find the operator providing the most favorable risk/reward balance with ease; and (2) place a bet electronically with the said operator, without having to open and manage a personal account at the operator.

### SUMMARY

The present disclosure teaches a computerized system, comprising: one or more hardware computer processors configured with computer-executable instructions that, when executed, cause the one or more hardware computer processors to: open a platform account at each of a first list of operators; identifying a second list of operators; gather individual sports gambling data from each of the second list of operators; aggregate the individual sports gambling data from the second list of operators into aggregated sports gambling data; display the aggregated sports gambling data to a user; receive an input from the user, wherein the input includes a target sport-related event, target odds, and a target monetary value; automatically monitor odds offered by the second list of operators for the target sport-related event till a target time at which the target sports event takes place; in response to that a target operator from the second list of operators offering odds at or exceeding the target odds: automatically taking a first payment corresponding to the target monetary value from the user; automatically place, via the platform account at the target operator, a bet on the target sport-related event of the target monetary value; notify the user of the placement of the bet; receive a result of the bet from the target operator; notify the user of the result; in response to that the user wins the bet: receive a payback from the target operator; send a second payment corresponding to an amount of the payback to the user; in response to that no operator from the second list of operators has offered odds at or exceeding the target odds till the target time: notify the user of the non-placement of the bet.

In some embodiments, the first payment may be no less than the target monetary value.

In some embodiments, the first payment may equal the target monetary value.

In some embodiments, the second payment may be no larger than the amount of the payback.

In some embodiments, the second payment may equal the amount of the payback.

In some embodiments, the individual sports gambling data may include a plurality of sport-related events and odds corresponding to each of the plurality of sport-related events.

In some embodiments, for the aggregation of the individual sports gambling data, most favorable odds corresponding to each of the plurality of sport-related events may be identified.

In some embodiments, for the display of the aggregated sports gambling data, the most favorable odds corresponding to each of the plurality of sport-related events may be highlighted.

In some embodiments, the one or more hardware computer processors are configured with computer-executable instructions that, when executed, may further cause the one or more hardware computer processors to: generate a prediction corresponding to each of the plurality of sport-related events.

In some embodiments, the prediction may include a probability.

In some embodiments, the prediction may further include a predictability.

In some embodiments, the prediction may be generated by a machine learning model trained with feature data, wherein the feature data may include sport-related statistics.

In some embodiments, the generation of a prediction corresponding to each of the plurality of sport-related events may include: gathering the feature data; feeding the feature data to the machine learning model; obtaining the prediction generated by the machine learning model; gathering an actual result of each of the plurality of the sport-related events; saving the actual result of each of the plurality of the sport-related events with the feature data; retraining the machine learning model on a batch basis with the actual result of each of the plurality of the sport-related events and the feature data.

In some embodiments, the identification of the second list of operators may include: identifying a state where a user locates in; checking if sports gambling is legal in the state; in response to that sports gambling is legal in the state: identifying a second list of operators that are legally available in the state.

In some embodiments, the identification of the second list of operators further includes: in response to that sports gambling is not legalized in the state: notifying the user.

In some embodiments, the one or more hardware computer processors are configured with computer-executable instructions that, when executed, may further cause the one or more hardware computer processors to: in response to that the target monetary value exceeds a first threshold: send a warning to the user.

In some embodiments, the first threshold may be preset by the user.

In some embodiments, the one or more hardware computer processors are configured with computer-executable instructions that, when executed, may further cause the one or more hardware computer processors to: calculate a total amount of money the user spends on bets for a time period; in response to that the total amount of money exceeds a second threshold; send a warning to the user.

In some embodiments, the second threshold may be preset by the user.

In some embodiments, the time period may be preset by the user.

### BRIEF DESCRIPTION OF THE DRAWINGS

The present disclosure is further illustrated by way of exemplary embodiments, which are described in detail through the accompanying drawings. These embodiments are not limiting, and in these embodiments, the same numbering indicates the same structure, wherein:

FIG. 1 is a block diagram illustrating the operation of the integrated computerized platform for sports gambling, according to some embodiments of the presently disclosed technology;

FIG. 2 is a block diagram illustrating modules of the integrated computerized platform manager for sports gambling, according to some embodiments of the presently disclosed technology;

FIG. 3 is a flow diagram illustrating the process of managing sports gambling data, by the sports gambling data management module, according to some embodiments of the presently disclosed technology;

FIG. 3A is a flow diagram illustrating the process of determining a plurality of legally available sports gambling operators in a state where a user resides, by the operator finding sub-module, according to some embodiments of the presently disclosed technology;

FIG. 3B is a flow diagram illustrating the process of generating predictions/recommendations, by the prediction management sub-module, according to some embodiments of the presently disclosed technology;

FIG. 4A is a flow diagram illustrating the process of a user placing a bet via the integrated computerized platform for sports gambling, by the bet management module, according to some embodiments of the presently disclosed technology;

FIG. 4B is a flow diagram illustrating the process of a user learning of the result of a bet and receiving a payback, if applicable, via the integrated computerized platform for sports gambling, by the bet management module, according to some embodiments of the presently disclosed technology;

FIG. 4C is a flow diagram illustrating a user placing a conditional bet via the integrated computerized platform for sports gambling, by the bet management module, according to some embodiments of the presently disclosed technology;

FIG. 5 shows one exemplary user interface of the integrated computerized platform for sports gambling, according to some embodiments of the presently disclosed technology;

FIG. 6 is a block diagram illustrating an exemplary device on which the presently disclosed technology may be implemented, according to some embodiments;

FIG. 7 is a diagram illustrating an exemplary networking environment in which the presently disclosed technology may be implemented, according to some embodiments.

### DETAILED DESCRIPTION

In order to more clearly illustrate the technical solutions of the embodiments of the present disclosure, the accompanying drawings for the description of the embodiments are described below. Obviously, the accompanying drawings in the following description are only some examples or embodiments of the present disclosure, and it is possible for a person of ordinary skill in the art to apply the present disclosure to other similar scenarios in accordance with these accompanying drawings without creative labor. Unless obviously obtained from the context or the context illustrates otherwise, the same numeral in the drawings refers to the same structure or operation.

It should be understood that the terms “system,” “device,” “unit,” and/or “module” are used herein as a way to distinguish between different components, elements, parts, sections, or assemblies at different levels. However, if other words may achieve the same purpose, the terms may be replaced with alternative expressions.

As indicated in the present disclosure and in the claims, unless the context clearly suggests an exception, the words “one,” “a,” “a kind of,” and/or “the” do not refer specifically to the singular but may also include the plural. In general, the terms “include” and “comprise” suggest only the inclusion of clearly identified steps and elements, which do not constitute an exclusive list, and the method or device may also include other steps or clements.

To address the problems discussed in the background section, the presently disclosed technology aims to provide a computerized platform (1) that aggregates and organizes data provided by a plurality of sports gambling operators, so that a user may browse sports gambling related data provided by different operators with case; (2) that opens and maintains a platform account at each of the plurality of sports gambling operators, so that a user may place a bet at any of the plurality of operators, get notified of the result, and receive a payback via the platform account, without having to open and maintain their personal account at the operator.

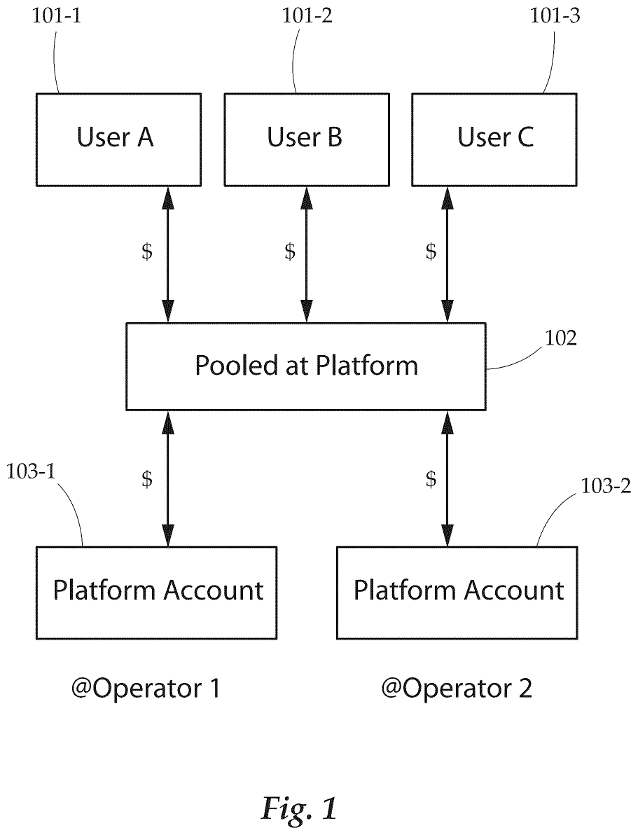

FIG. 1 is a block diagram illustrating the flow of funds on an integrated computerized platform for sports gambling, according to some embodiments of the presently disclosed technology.

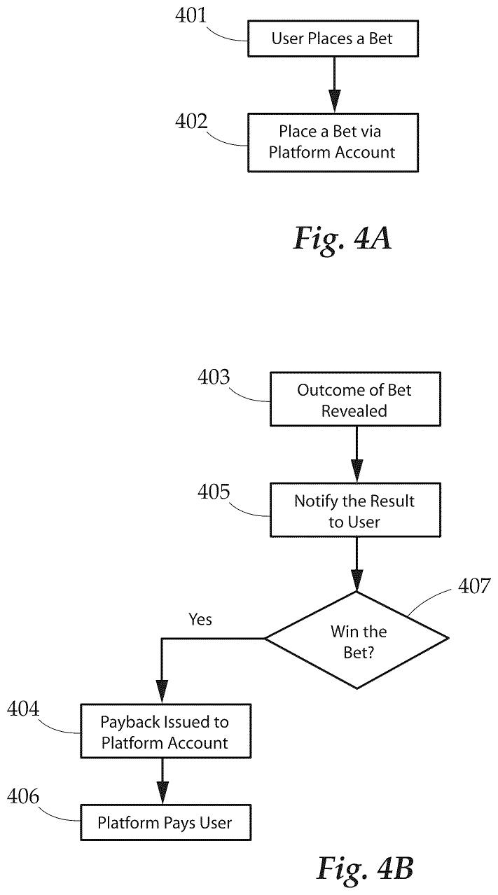

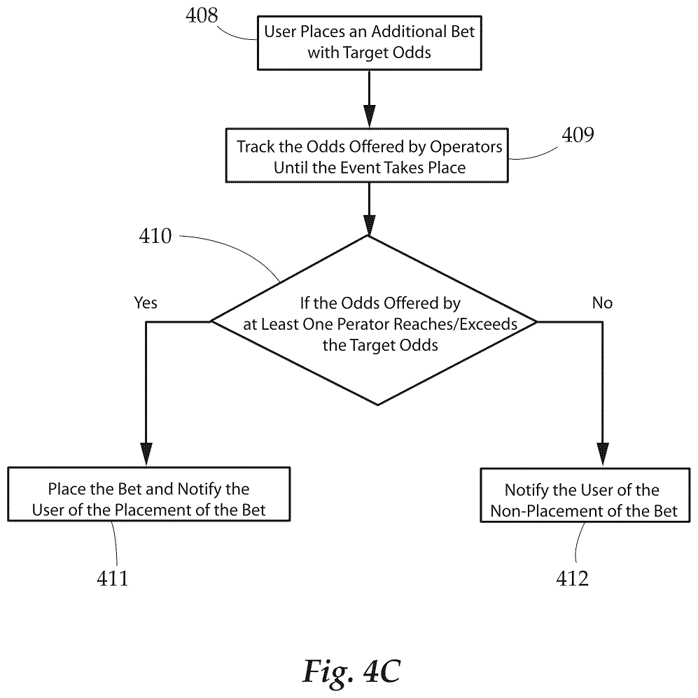

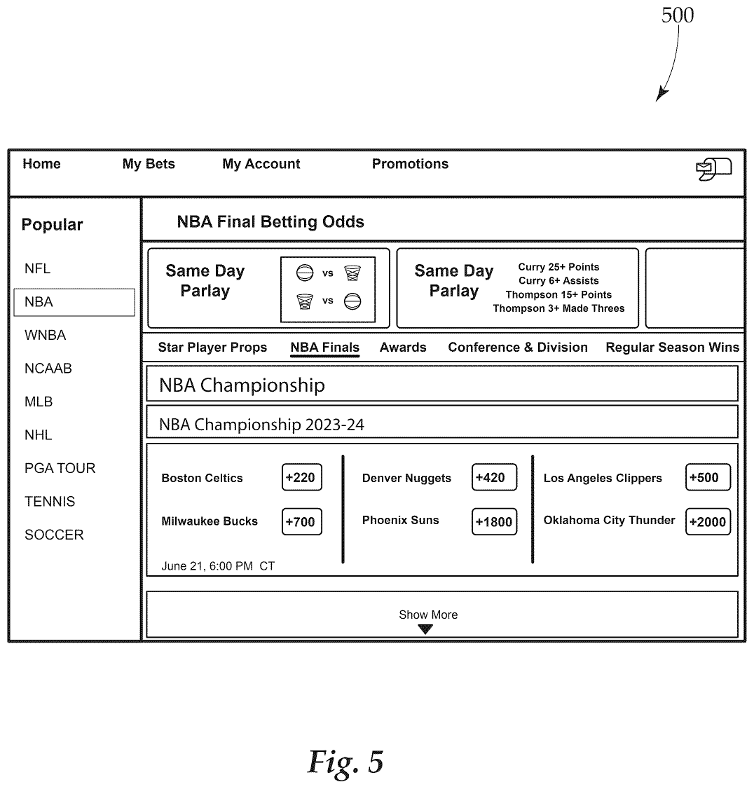

In some embodiments, the presently disclosed technology teaches an integrated computerized platform 102 for sports gambling (“the platform”), via which a user can place a bet on any of a plurality of operators. The platform 102 is electronically implemented and managed on one or more computing devices 400, as shown by FIG. 4, which will be discussed in detail in the later paragraphs. The platform 102 is electronically implemented and managed in the network environment 700, as shown by FIG. 5, which will also be discussed in detail in the later paragraphs.

To place a bet, the user, from the user system 702, would electronically transfer a first amount from their fund 101-1, 101-2, or 101-3 onto the platform 102 via the connections 701. In typical embodiments, payment from all users gets pooled at the platform 102. The first amount may equal the amount of the bet, or may be slightly larger, so that the platform 102 could receive a fee for its service. The platform 102 may electronically open and maintain platform accounts at each of the operators, as indicated by 103-1 and 103-2 in FIG. 1. These accounts may correspond to a particular platform user, 101-1, 101-2, 101-3, or may correspond to the pooled account-with accounting to each platform user 101-1, 101-2, 101-3 recorded by the computerized system. Bets could be electronically placed via the platform accounts, and paybacks would also be electronically issued to the platform accounts. In the embodiment shown, all bets, from all users of the platform 102, at a specific operator, would go through the same platform account. For example, if User A would like to place a bet on “Shai wins the 2024 NBA MVP” for $200 at operator 1, an amount of $200 will be transferred from 101-1 to the platform 102, and eventually placed on the said event via the platform account 103-1. If Shai indeed wins the 2024 NBA MVP, the payback will be issued by operator 1 to the platform account 103-1, and a second amount would be electronically transferred back to User A's fund 101-1 via the platform 102. The second amount may equal the payback, or may be slightly smaller, so that the platform 102 could receive a fee for its service.

Alternatively, a user may store an amount of money on the platform 102, so that they do not have to make a transfer when placing a bet, or only have to make a partial transfer. The amount of money may be held on individual accounts on the platform 102. Likewise, when the platform 102 receives a payback in one of its platform accounts 103-1 or 103-2, all or a part of the payback may be stored in the platform account or on an individual account on the platform, so the payment may not be immediately made to the user at 101-1, 101-2, or 101-3, or may only be partially made to the user. In some embodiments, the platform 102 may provide a reward for promotional purposes, so that the first amount might be less than the amount of the bet, or the second amount might be larger than the payback. In some embodiments, the first amount and/or the second amount may be paid in installments. In some embodiments, an interest may be included for the payment of the first amount or the second amount.

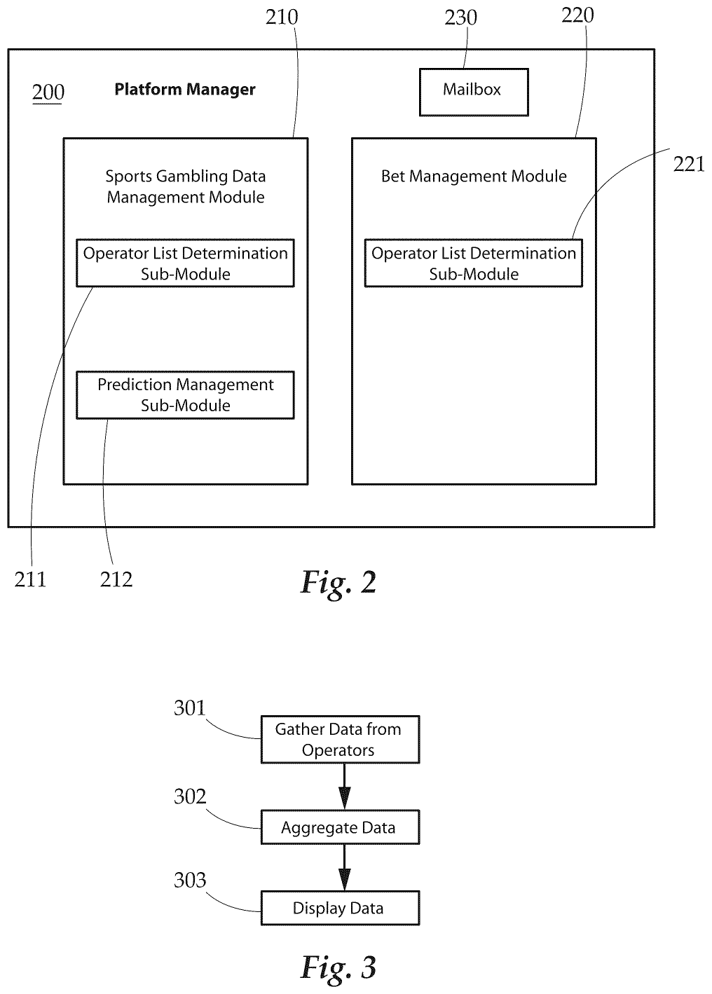

FIG. 2 is a block diagram illustrating modules of the integrated computerized platform manager for sports gambling, according to some embodiments of the presently disclosed technology.

The platform manager 200 may electronically manage the operators of the platform 102, by one or more processors 603. The platform manager 200 may include three modules, wherein, each module is a set of programming instructions stored on a memory operable to cause the one or more processors 603 to perform certain functions: the sports gambling data management module 210, for electronically gathering, aggregating, organizing, and displaying sports gambling data from a plurality of operators; the bet management module 220, via which a user can place and manage their bets; and the mailbox 230, via which a user can receive notifications about the status of their bets, promotional information, warnings, recommendations, etc.

The sports gambling data management module 210 may further include two sub-modules, wherein, each sub-module is a set of programming instructions stored on a memory operable to cause the one or more processors 603 to perform certain functions: the operating finding sub-module 211, for determining a list of legally available operators in a state where a user is located; and the prediction management sub-module 212, for making predictions for a plurality of sport-related events.

The bet management module 220 may further include one sub-module, wherein, each sub-module is a set of programming instructions stored on a memory operable to cause the one or more processors 603 to perform certain functions: the responsible gambling sub-module 221, for displaying a warning to a user when the amount of the bet exceeds a first threshold, or the total amount of bets the user placed over a certain time period exceeds a second threshold.

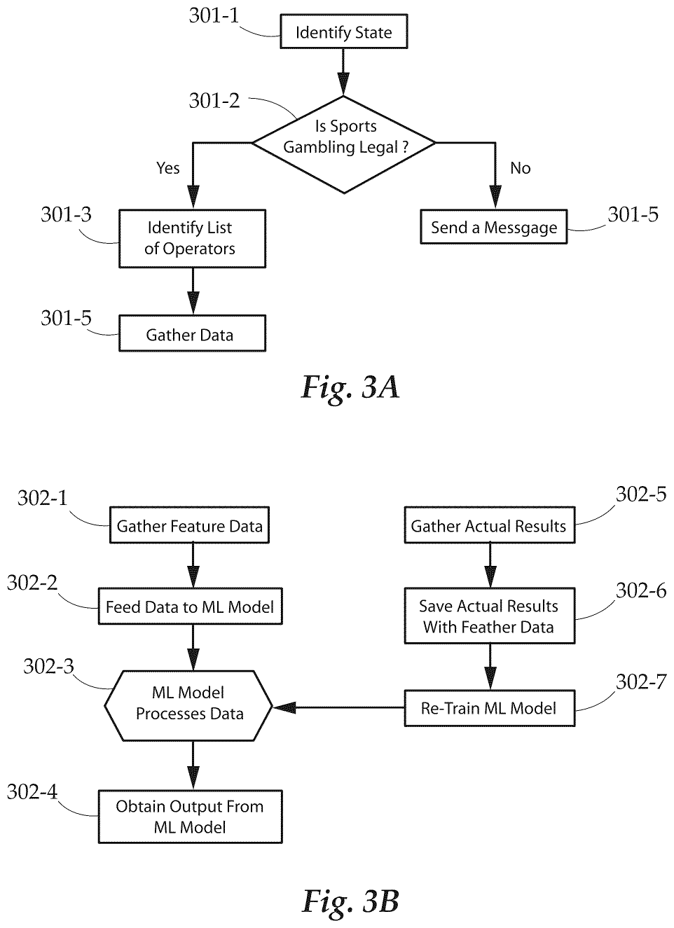

FIG. 3 is a flow diagram illustrating the process of managing sports gambling data, by the sports gambling data management module 210, according to some embodiments of the presently disclosed technology.

At step 301, the sports gambling data management module 210 may gather, by one or more processors 603, data from a plurality of operators.

As discussed above, each state of the U.S. may have different sports gambling laws, and each state may have a different set of legally available operators for sports gambling. Therefore, the sports gambling data management module 210 may need to know where a user resides before gathering data from operators.

FIG. 3A is a flow diagram illustrating the process of determining a plurality of legally available sports gambling operators in a state where a user resides, by the operator finding sub-module 211, according to some embodiments of the presently disclosed technology.

At step 301-1, the operator finding sub-module 211 may identify, by one or more processors 603, the state where a user resides. In some embodiments, such identification can be realized by tracking the user's IP address, GPS, Wi-Fi data, or Bluetooth information, etc. Such data related to a user's IP location/physical location may be transferred from the user system 702 to the service terminal 703 via the connections 701. In some embodiments, the user may also manually input the name of the state where they reside.

At step 301-2, the operator finding sub-module 211 may check, by one or more processors 603, if sports gambling is legal in the said state. Such information may either be retained in the sports gambling related data 624 or obtained from an internet search. If the information is retained in the sports gambling related data 624, it should be updated periodically.

If the answer is yes, at step 301-3, the operator finding sub-module 211 may identify, by one or more processors 603, a list of legally available operators for sports gambling in the said state. Likewise, such information may either be retained in the sports gambling related data 724 or obtained from an internet search; if the information is retained in the sports gambling related data 724, it should be updated periodically.

If the answer is no, at step 301-4, the operator finding sub-module 211 may send, by one or more processors 603, a message back to the user, indicating that sports gambling is illegal in the state where the user currently resides.

At step 301-5, the sports gambling data management module 210 may gather, by one or more processors 603, sports gambling data from the identified list of legally available operators in the said state. The sports gambling data may include two parts: a plurality of sport-related events (“events”) and the line (odds, payback) corresponding to each of the plurality of events. The events may be from a wide range of sports and sports leagues, including but not limited to NFL, NBA, MLB, NHL, college football and basketball, boxing, international sports, etc. The events may be of different types, including but not limited to which team wins a game, by how many points, player's statistics, which teams make the playoffs, which team wins the championship, which player wins which award, which player makes the first field goal, during which regular season game Lebron James scores his 40,000^{th} point, etc. The events may either be based on a future game or a live game. The line may also be represented in different formats, including but not limited to European format (decimal odds), UK format (fractional odds), or American format (money line odds), etc. At step 301-5, the sports gambling data is transferred from the operator system 704 to the service terminal 703 via the connections 701.

At step 302, the sports gambling data management module 210 may aggregate, by one or more processors 603, the sports gambling data. For each event, the sports gambling data management module 210 may find the line offered by each of the operators, convert the line to a unified format (the American format, for example), compare the line and finds the most favorable line, as well as identifying the operator offering the most favorable line.

In some embodiments, the aggregated sports gambling data also includes the predictions of the platform, provided by the prediction management sub-module 212. For example, the predictions/recommendations may come from reputable sports commentators, retrieved from the internet. For another example, the prediction management sub-module 212 may establish its own machine learning model to make predictions/recommendations.

FIG. 3B is a flow diagram illustrating the process of generating predictions/recommendations, by the prediction management sub-module, according to some embodiments of the presently disclosed technology. As will be discussed below, the presently disclosed technology aims to solve the computerized problem of generating predictions for sport-related events using machine learning algorithms.

At step 302-1, the prediction management sub-module 212 may gather, by one or more processors 603, feature data. The feature data may include various types of player statistics and team statistics. The feature data may further include sports news, video recordings of past games, notes from reputable sports commentators, etc. The line offered by sports gambling operators themselves may also be used as a part of the training data, as they reflect the predictions of operators and gamblers. The feature data may either be retained in the sports gambling related data 624 or obtained from an internet search. If the feature data is retained in the sports gambling related data 624, it should be updated periodically. The feature data may or may not be pre-processed before fed to the machine learning model. The pre-processing of the feature data may include, for example, converting statistics to a uniformed format, performing a Natural Language Processing (NLP) analysis on textual information, and/or applying object detection, object tracking, and action recognition on videos, etc.

At step 302-2, the prediction management sub-module 212 may feed, by one or more processors 603, the feature data to a machine learning model. At step 302-3, the machine learning module may process the feature data. The machine learning model can utilize one or a combination of machine learning algorithms, such as decision trees, random forests, Bayesian models, support vector machines (SVM), k-nearest neighbors (k-NNs), neural networks, etc. The machine learning model may be a supervised learning model, or an unsupervised learning model.

At step 302-4, the prediction management sub-module 212 may obtain, by one or more processors 603, the output of the machine learning model. The output of the machine learning model may represent a prediction given by the platform. For example, the output of the machine learning model may include a probability corresponding to an event (e.g. “the probability of Shai winning the 2024 NBA MVP is 17.0%). The output may also include a “predictability” of the event. Some events can be predictable to a certain degree. For example, in 2024, Boston Celtics is a lot more likely to win the NBA championship than Los Angeles Lakers, even though it's not impossible for the Lakers to win the championship. Some events can be hardly predictable. For example, a bet like “who make the first field goal in the next Lakers game” may have an almost random outcome.

At step 302-5, the prediction management sub-module 212 may, by one or more processors 603, data describing the actual results of sport-related events. Such data may either be obtained via the platform accounts, or from an internet search.

At step 302-6, the prediction management sub-module 212 saves the data describing the actual results of sports-related events, along with the corresponding feature data, in the sports gambling related data 624.

At step 302-7, the prediction management sub-module 212 retrains the machine learning module with the data describing the actual results of sports-related events, along with the corresponding data, on a batch basis. Therefore, the performance of the machine learning model may be improved with accumulation of data.

Sports can be a very emotional topic. Therefore, it is hard to make a neutral and unbiased judgment when you make a bet in sports gambling. A user's judgment may be influenced by various irrational factors unrelated to the actual performance of players, such as which team the user supports, which teams the user's friends and family support, which team has the largest fanbase, which team is in a bigger market, etc. For example, mediocre teams with large fanbases and heavy media exposures are often overrated. The line offered by operators can also be influenced by these irrational factors. Therefore, by offering predictions/recommendations made from raw statistics, in a neutral and unbiased manner, the presently disclosed system may help a user make informed decisions, and potentially get a better outcome from sports gambling.

At step 303, the sports gambling data management module 210 may display, by one or more processors 603, the aggregated sports gambling data to a user on the user interface 500. The services terminal 703 may send the aggregated sports gambling data to the user system 702 via the connections 701. In the user system 702, the aggregated sports gambling data will be displayed on the user interface 500. Details regarding the user interface 500 will be discussed in greater detail in FIG. 5 and the corresponding paragraphs.

When a user interface contains too much information, efficient and effective displays of information are critical. The presently disclosed technology offers additional features to help organize information of different priorities on a computer-based user interface. For example, the most important information, such as the most favorable line, may be highlighted; and less important information, such as other operators' offerings, may be collapsed or minimized. In some embodiments, only the most favorable line corresponding to each event may be displayed to a user via a user interface. For example, if operators A, B, and C gives lines of +240, +230, and +235 for “Shai wins the 2024 NBA MVP”, only the +240 line would be shown to the user, since a rational user would most likely place a bet at operator A to maximize their potential monetary gain. In some other embodiments, all lines may be displayed to a user on the user interface, but only the most favorable line may be highlighted. In some embodiments, the name of the operator providing the line may also be shown next to the line. In some embodiments, the prediction/recommendation of the platform may also be shown. For example, under a tab “2024 NBA MVP”, a row may read like: “Shai Gilgcous-Alexander, +240, 17%”. Such prediction/recommendation can help sports gamblers stay informed and make decisions accordingly. Moreover, users can efficiently gather consolidated information from a single interface, and do not have to do their own research and switch back and forth from different pages. Keeping users engaged on a single user interface, without requiring navigating away, substantially increases engagement, as it is common that users will navigate away from a user interface, never to return. The present invention solves this problem by consolidating and containing information in the single platform user interface. For example, in some embodiments, events with the best or worst risk/reward balances may be highlighted. For example (although it's very unlikely to happen in real life), if a row reads like “Event A, +10000, 99%”, it would be very desirable for a user to make a bet on event A. For another example, if a row reads like “Event B, −10000, 1%”, a user should be warned against placing such a bet.

Like discussed above, information of relatively low importance might be minimized or collapsed for an efficient display of information on a computer-based user interface. In some embodiments, information of relatively low importance, such as the name of the operator offering the most favorable line, as well as the names of other available operators and the less favorable lines they offer, may be hidden, but can be viewed once a user clicks on an entry or hover their cursor over an entry. For example, a row may read like “Shai Gilgeous-Alexander, +240”. When a user hovers their cursor over the +240, a bubble with the text “Draft Kings” (the corresponding operator's name) may pop up. When a user further clicks on the +240, a floating window may pop up, showing a table listing all the other operators and the lines they offer, may pop up.

FIG. 4A is a flow diagram illustrating the process of a user placing a bet via the integrated computerized platform for sports gambling, by the bet management module 220, according to some embodiments of the presently disclosed technology.

At 401, the user may place a bet via the bet management module 220. At least three pieces of information may be used to describe the bet: a target event, a target operator, and a target amount. For most of the time, a rational user would choose to place a bet at the operator offering the most favorable line. The above discussed features provided by the presently disclosed technology will enable the user to identify the operator offering the most favorable line, and placing a bet with them electronically, with case. For example, the user can place a bet by clicking on the most favorable line and will be redirected to a page where they can complete the bet-placing process (or alternatively, a window will pop up). The user could save the trouble of going to the operator's website and placing a bet from there, and neither has to electronically open and maintain an account for the particular operator. However, a user may also want to place a bet at a different operator for various reasons, and the presently disclosed technology will also enable the user to place the bet at the “less favorable” operator via the platform. For example, the user may click on a “less favorable” line or on a “less favorable” operator's name and will be redirected to a page where they can completed the bet-placing process. These three pieces of information will be electronically transferred from the user system 702 to the service terminal 703, via the connections 701. As discussed above, a user may electronically submit a first payment, no smaller than the target amount, to the platform 102.

In some embodiments, the bet management module 220 would include a responsible gambling module 221 to help users gamble responsibly. For example, in some embodiments, if the target amount exceeds a threshold, the responsible gambling module 221 may send a warning to the user. The threshold may be a default amount or preset by the user. The threshold may also equal to a certain percentage of the user's annual income, for example. In some other embodiments, the responsible gambling module 221 may also keep track of the total amount a user spent on sports gambling during a time period (for example, a week, a month, or a year), and send a warning to the user when the total amount exceeds a threshold.

At 402, as discussed above, the bet management module 220 would electronically place a bet for the target event, of the target amount, at the target operator, via the platform account the platform 102 has opened and maintained at the target operator.

FIG. 4B is a flow diagram illustrating the process of a user learning of the result of a bet and receiving a payback, if applicable, via the integrated computerized platform for sports gambling, by the bet management module 220, according to some embodiments of the presently disclosed technology.

At 403, the outcome of the bet will be revealed. The operator system 704 would send, by one or more processors 603, the outcome of the bet to the service terminal 703 via the connections 701, through the platform account. If the user wins the bet, as discussed above, at 404, a payback would be issued to the platform account.

At 405, regardless of whether the user wins or loses the bet, the bet management module 220, will electronically send, by one or more processors 603, a message indicating the outcome of the bet to the user via the mailbox 230.

At 406, if the user wins the bet, as discussed above, a second payment, no larger than the payback, will be electronically transferred from the platform account to the user, a message will be sent via the mailbox 230 as a confirmation for the second payment.

FIG. 4C is a flow diagram illustrating a user placing a conditional bet via the integrated computerized platform for sports gambling, by the bet management module 220, according to some embodiments of the presently disclosed technology.

Sometimes, a user may wish to place a bet at or exceeding a target line or target odds to maximize their potential return or minimize their potential risk. For example, a user may log onto the platform on Tuesday and would like to place a bet on the Patriots winning the Sunday game at the odds of +300 or above. Nevertheless, the best offer among the operators may be +250 at that time. In this case, the user may place a conditional bet on the event of “Patriots winning the Sunday game” at target odds of +300. The platform may monitor the odds for the event among the operators over a time period from Tuesday to Sunday, and automatically place the bet if an operator offers odds at +300 or more during the time period. If no operator offers such odds till the game time on Sunday, the platform will not place the bet.

At 408, the user may place a conditional bet via the bet management module 220. The conditional bet may contain at least three pieces of information: a target event, target odds, and a target amount of money for the conditional bet. As discussed above, at the time of placing the conditional bet, no operator may be able to offer odds at or exceeding the target odds. In some embodiments, the user may only want to place the conditional bet via one or a few selected operators and may indicate so at 408.

At 409, from the time the user places the conditional bet to the time the target event happens, the bet management module 220 of the platform may track the odds for the target event offered by the available or selected operators. This tracking may be automated, which means the user does not have to log onto the platform for such tracking.

At 410, during the time period of the platform tracking the odds for the target event, if at least one of the operators offers odds at or exceeding the target odds, the bet management module 220 may automatically place the bet for the target event and of the target amount for the user at 411. The user may not need to log onto the platform to place the bet. The bet management module 220 may also, electronically send, by one or more processors 603, a message indicating placement of the bet to the user via the mailbox 230.

If, at 410, from the time of placing the conditional bet till the target event happens, no operator has offered odds at or exceeding the target odds, the bet management module 220 may not place the bet. In which case, at 412, the bet management module 220 may, electronically send, by one or more processors 603, a message indicating no placement of the bet to the user via the mailbox 230.

In some embodiments, the user may cancel a conditional bet before the bet is placed via the bet management module 220, so the tracking of odds for the target event may be stopped.

FIG. 5 shows one exemplary user interface 500 of the integrated computerized platform for sports gambling, according to some embodiments of the presently disclosed technology. Note that the interface of the presently disclosed technology may be implemented in many ways. The example embodiments described herein do not constitute limitations upon the scope of the present disclosure. The interface 500 can be displayed on one or more devices of the user system 702, according to some embodiments. The interface 500 may be displayed on a monitor, a touchscreen, the display screen of a computing device such as a desktop, a laptop, a smartphone, a tablet, a smartwatch, etc. The layout of the interface 500 may be modified according to the shape and the size of the device on which the interface is displayed.

According to some embodiments, the aggregated sports gambling data is displayed on the user interface 500. The aggregated sports gambling data may show a plurality of sports-related events, as well as the most favorable line offered by the plurality of available operators for each of the sports-related events. The plurality of sports-related events may be organized in different categories, to facilitate a user's browsing. For example, the plurality of sports-related events may be organized according to different sports leagues, such as NFL, NBA, MLB, NCAA basketball, etc. For another example, the plurality of sports-related events may further be organized according to different types of the events, such as which team wins the game, the star player's statistics in a game, which teams make the playoffs, which player wins which award, which team wins the championship, etc. The user interface 500 may include a vertical navigation panel and/or a horizontal navigation panel listing the different categories, so that the user may click on a category to view sports-related events under the said category. The vertical navigation panel and the horizontal navigation panel may categorize the plurality of sports according to different dimensions. For example, the vertical navigation panel may list the names of different sports leagues, and the horizontal navigation panel may list various types of sports-related events, such as “Star Player Props”, “NBA Finals”, “Awards”, “Regular Season Wins”, etc.

In some embodiments, the most favorable line corresponding to each sports-related event will be shown next to the name of the event. In some embodiments, additional information including but not limited to the name of the operator providing the most favorable line, the names of other operators and the lines they provide, will be displayed when the user clicks on the line or the name of the event, or hovers their cursor over the line or the name of the event, as discussed in the previous paragraphs. In some embodiments, the additional information may also be displayed in other manners. As discussed above, in some embodiments, a prediction may be displayed next to the line.

As discussed above, in some embodiments, the user may place a bet by clicking on the line. The platform manager 200 will re-direct the user to another webpage or view, or a floating window will pop up, for the user to complete the transaction.

In some embodiments, the user interface 500 contains a tab titled “My Bet” on the top of it. The user may view all the bets they have placed, managed by the bet management module 220, by clicking on the tab “My Bet”. In some embodiments, the user interface 500 contains another tab titled “My Account” on the top of it. The user may view their account balance and past transaction history, also managed by the bet management module 220, by clicking on the tab “My Account”.

In some embodiments, the user interface 500 includes a mailbox icon in the top right corner. The user may view messages from the service terminal 703, managed by the mailbox 230, by clicking on the mailbox icon. The messages may include results of previous bets, promotion info, important sports news, recommendations, etc. If there are unread messages, a small bubble may appear on the mailbox icon as a reminder.

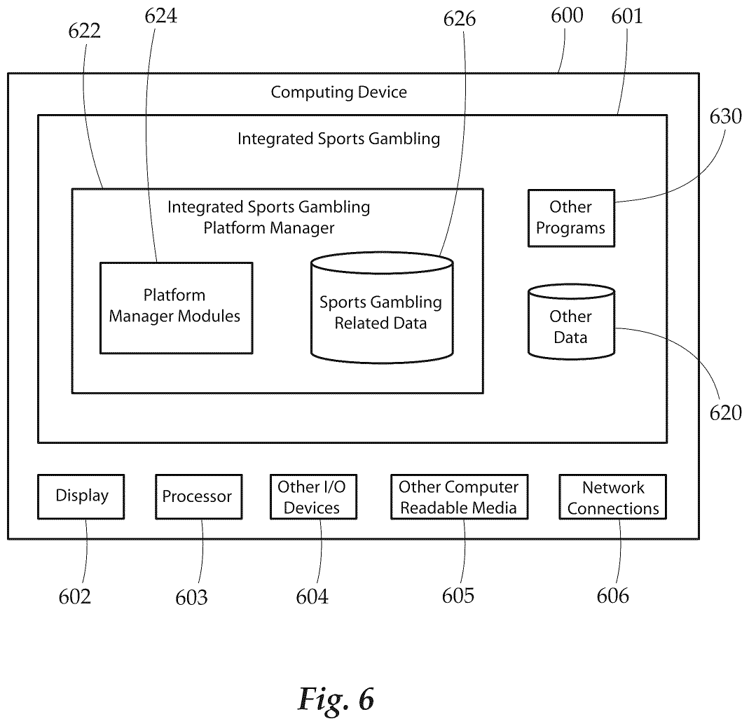

FIG. 6 is a block diagram illustrating elements of an example computing device 600 utilized in accordance with at least some embodiments of the techniques described herein. Illustratively, the computing device 600 corresponds to the service terminal 703, on which the previously disclosed methods as illustrated in FIGS. 2, 3, 3A-B, 4A-B are performed, according to some embodiments. The computerized method may also be performed on one or more devices connected by a local network or connected to the internet. For example, if the amount of sports gambling data is enormous, the gathering of sports gambling data may be performed by multiple computing devices in parallel. The different functions in the method may also be performed on different devices. For example, the displaying of aggregated sports gambling data may be performed on the user system 702.

In some embodiments, one or more general purpose or special purpose computing systems or devices may be used to implement the computing device 600. In addition, in some embodiments, the computing device 600 may comprise one or more distinct computing systems or devices and may span distributed locations. For example, each block shown in FIG. 6 may represent one or more specific embodiments or may be combined with other blocks. Also, the integrated sports gambling platform manager 622 may be implemented in software, hardware, firmware, or in some combination to achieve the capabilities described herein.

As shown, the computing device 600 comprises a non-transitory computer memory (“memory”) 601, a display 602 (including, but not limited to a light emitting diode (LED) panel, cathode ray tube (CRT) display, liquid crystal display (LCD), touch screen display, projector, etc.), one or more CPUs, GPUs, other processors, 603, Input/Output (“I/O”) devices 604 (e.g., keyboard, mouse, RF or infrared receiver, universal serial bus (USB) ports, High-Definition Multimedia Interface (HDMI) ports, other communication ports, and the like), other computer-readable media 605, and network connections 606. The integrated sports gambling platform manager is shown residing in the memory 601. In other embodiments, some portion of the contents and some, or all, of the components of the integrated sports gambling platform manager 622 may be stored on or transmitted over the other computer-readable media 605. The components of the computing device 600 and the integrated sports gambling platform manager 622 can executed on one or more processors 603 and implement applicable functions described herein. In some embodiments, the integrated sports gambling platform manager 622 may operate as, be part of, or work in conjunction or cooperation with other software applications stored in memory 601 or on various other computing devices. In some embodiments, the integrated sports gambling platform manager 622 also facilitates communication with peripheral devices via the I/O devices 604, or with another device or system via the network connections 606.

The one or more platform manager modules 624 are configured to perform actions, directly or indirectly, to gather sports gambling data from the plurality of sports gambling operators, aggregate the sports gambling data, display the aggregated sports gambling data, receive bet placements, placing bets at the plurality of operators via platform accounts, receive bet results from the plurality of operators, send messages to users regarding bet results, receive paybacks from the plurality of operators via platform accounts, and send payments back to users, etc. The one or more platform manager modules 624 may also be configured to determine the state a user locates in, identify the plurality of operators legally operates in the state, generate predictions/recommendations corresponding to the plurality of sports-related events, send a warning to the user when the amount of a bet exceeds a first threshold, send a warning to a user when the total amount of bets a user placed during a time period exceeds a second threshold, etc. In some embodiments, the integrated sports gambling module(s) 624 stores, retrieves, or otherwise accesses at least some sports gambling related data 616 or other data storage internal or external to the computing device 600.

Other code or programs 630 (e.g., further data processing modules, a program guide manager module, a Web server, and the like), and potentially other data repositories, such as data repository 620 for storing other data, may also reside in the memory 601, and can execute on one or more processors 603. Of note, one or more of the components in FIG. 6 may or may not be present in any specific implementation. For example, some embodiments may not provide other computer readable media 605 or a display 602.

In some embodiments, the computing device 600 and integrated sports gambling platform manager 622 include API(s) that provides programmatic access to add. remove, or change one or more functions of the computing device 600. In some embodiments, components/modules of the computing device 600 and integrated sports gambling platform manager 622 are implemented using standard programming techniques. For example, the integrated sports gambling platform manager 622 may be implemented as an executable running on the processor(s) 603, along with one or more static or dynamic libraries. In other embodiments, the computing device 600 and integrated sports gambling platform manager 622 may be implemented as instructions processed by a virtual machine that executes as one of the other programs 630. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript. VBScript, and the like), or declarative (e.g., SQL, Prolog, and the like).

In a software or firmware implementation, instructions stored in a memory configure, when executed, one or more processors of the computing device 600 to perform the functions of the integrated sports gambling platform manager 622. In some embodiments, instructions cause the processor(s) 603 or some other processor, such as an I/O controller/processor, to perform at least some functions described herein.

The embodiments described above may also use well-known or other synchronous or asynchronous client-server computing techniques. However, the various components may be implemented using more monolithic programming techniques as well, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs or other processors. Some embodiments may execute concurrently and asynchronously and communicate using message passing techniques. Equivalent synchronous embodiments are also supported by an integrated sports gambling platform manager 622 implementation. Also, other functions could be implemented or performed by each component/module, and in different orders, and by different components/modules, yet still achieve the functions of the computing device 600 and integrated sports gambling platform manager 622.

In addition, programming interfaces to the data stored as part of the computing device 600 and integrated sports gambling platform manager 622, can be available by standard mechanisms such as through C, C++, C#, and Java APIs; libraries for accessing files, databases, or other data repositories; scripting languages such as XML; or Web servers, FTP servers, NFS file servers, or other types of servers providing access to stored data. The electronic updates-related data storage 616 and data repository 620 may be implemented as one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, and Web Services (XML-RPC, JAX-RPC, SOAP, and the like). Other variations are possible. Other functionality could also be provided by each component/module, or existing functionality could be distributed amongst the components/modules in different ways, yet still achieve the functions of the integrated sports gambling platform manager 622.

Furthermore, in some embodiments, some or all of the components of the computing device 600 and integrated sports gambling platform manager 622 may be implemented or provided in other manners, such as at least partially in firmware or hardware, including, but not limited to one or more application-specific integrated circuits (“ASICs”), standard integrated circuits, controllers (e.g., by executing appropriate instructions, and including microcontrollers or embedded controllers), field-programmable gate arrays (“FPGAs”), complex programmable logic devices (“CPLDs”), and the like. Some or all of the system components or data structures may also be stored as contents (e.g., as executable or other machine-readable software instructions or structured data) on a computer-readable medium (e.g., as a hard disk; a memory; a computer network, cellular wireless network or other data transmission medium; or a portable media article to be read by an appropriate drive or via an appropriate connection, such as a DVD or flash memory device) so as to enable or configure the computer-readable medium or one or more associated computing systems or devices to execute or otherwise use, or provide the contents to perform, at least some of the described techniques.

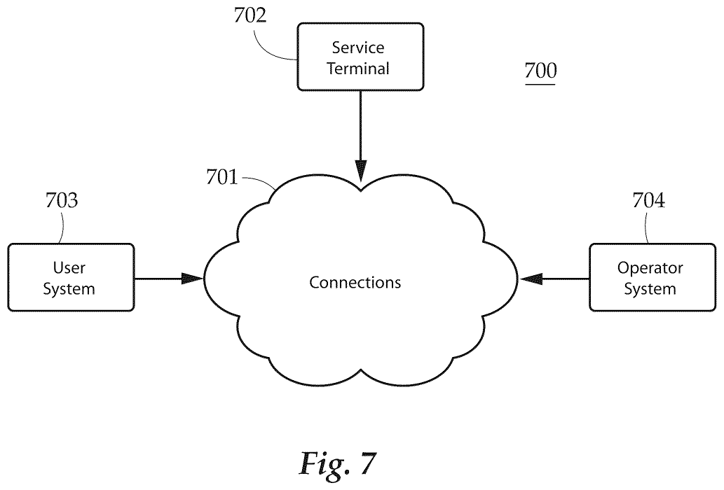

FIG. 7 is a diagram showing an exemplary networking environment 700 in which embodiments of the presently disclosed technology may be implemented, according to one example embodiment. The connections 701 may be a local network or the internet. The connections 701 may be implemented by software and hardware means. The software part of the connections 701 may comprise implementation of network protocols, such as TCP, UDP, IP. etc. The hardware part of the connections 701 may contain components such as switches, routers, cables and satellites that enables a variety of computing devices to communicate with each other.

The user system 702 can contain a desktop or laptop computer, smartphone, tablet, smartwatch, or other computing devices. The user system 702 can contain one or more I/O devices that enable the user to communicate with the computing device, such as keyboards, mice, touchscreens, microphones, cameras, display screens, speakers, etc. The user system 702 can contain one or more network devices that enable the user system to communicate with the service terminal 703 and the operator system 704 via the connections 701, such as routers, switches, cables, etc. The computing device can contain I/O and network modules that enable the computing device to access the I/O and network devices. The user may interact with the presently disclosed system via an interface 500, which will be described in further detail below, from the user system 702. The user system 702 may perform part of the presently disclosed computerized method, for example, determining the probability that an asset is impacted by an event.

Service terminal 703 can contain a server or other computing devices. The service terminal 703 can contain one or more network connection modules that enable the service terminal to communicate with the user system 702 and the operator system 704 via the connections 701. According to some embodiments, the service terminal may perform the entire or part of the presently disclosed computerized method. The presently disclosed computerized method may also be performed by multiple service terminals 703. For example, if the number of electronic updates is enormous, the gathering of feature data from electronic updates may be performed by multiple service terminals 703 in parallel. Part of the presently disclosed computerized method may also be performed by the user system 702 and the operator system 704.

The operator system 704 can contain a desktop or laptop computer, smartphone, tablet, smartwatch, or other computing devices. The operator system 704 can contain one or more I/O devices that enable the user to communicate with the computing device, such as keyboards, mice, touchscreens, microphones, cameras, display screens, speakers, etc. The operator system 704 can contain one or more network devices that enable the user system to communicate with the service terminal 703 and the operator system 704 via the connections 701, such as routers, switches, cables, etc. The computing device can contain I/O modules and network modules that enable the computing device to access the I/O devices and network devices. The operator system 704 may perform part of the presently disclosed computerized method, for example, gathering feature data from electronic updates.

One or more of the user system 702 and the operator system 704 may include one or more hardware and/or software components corresponding to those of computing device 600 as applicable to perform the functions of the user system 702 and the operator system 704 as described herein.

Furthermore, unless explicitly stated in the claims, the use of order, numbers, letters, or other names for processing elements and sequences are not intended to limit the order of the processes and methods of the present disclosure. While various examples have been discussed in the disclosure as currently considered useful embodiments of the invention, it should be understood that such details are provided for illustrative purposes only. The appended claims are not limited to the disclosed embodiments, and instead, the claims are intended to cover all modifications and equivalent combinations within the scope and essence of the embodiments disclosed in the present disclosure. For example, although the described system components may be implemented through a hardware device, they may also be realized solely through a software solution, such as installing the described system on an existing processing or mobile device.

Similarly, it should be noted that, for the sake of simplifying the presentation of embodiments disclosed in the present disclosure and aiding in understanding one or more embodiments of the present disclosure, various features have been sometimes combined into a single embodiment, drawing, or description. However, this manner of disclosure does not imply that the features required by the claims are more than the features mentioned in the claims. In fact, the features of the embodiments are less than all the features of the single embodiment disclosed in the foregoing disclosure.

In some embodiments, numeric values describing the composition and quantity of attributes are used in the description. It should be understood that such numeric values used for describing embodiments may be modified with qualifying terms such as “about,” “approximately” or “generally”. Unless otherwise stated, “about,” “approximately” or “generally” indicates that a variation of ±20% is permitted in the described numbers. Accordingly, in some embodiments, the numerical parameters used in the disclosure and claims are approximations, which can change depending on the desired characteristics of the individual embodiment. In some embodiments, the numerical parameters should take into account a specified number of valid digits and employ a general manner of bit retention. Although the numerical ranges and parameters used in some embodiments of the present disclosure to confirm the breadth of the range are approximations, in specific embodiments, such numerical values are set as precisely as practicable.

With respect to each of the patents, patent applications, publications of patent applications, and other material, such as articles, books, specifications, publications, documents and the like, cited in the present disclosure, the entire contents thereof are hereby incorporated herein by reference. Application history documents that are inconsistent with the contents of the present disclosure or that create conflicts are excluded, as are documents (currently or hereafter appended to the present disclosure) that limit the broadest scope of the claims of the present disclosure. It should be noted that in the event of any inconsistency or conflict between the descriptions, definitions, and/or use of terminology in the materials appended to the present disclosure and the contents described herein, the descriptions, definitions, and/or use of terminology in the present disclosure shall prevail.

In closing, it should be understood that the embodiments described in the present disclosure are used only to illustrate the principles of the embodiments of the present disclosure. Other deformations may also fall within the scope of the present disclosure. Therefore, by way of example and not limitation, alternative configurations of the embodiments disclosed in the present disclosure may be considered consistent with the teachings of the present disclosure. Accordingly, the embodiments described in the present disclosure are not limited to the explicitly introduced and described embodiments in the present disclosure.

What is claimed is:

1. A computerized system, comprising:
one or more hardware computer processors configured with computer-executable instructions that, when executed, cause the one or more hardware computer processors to:
open a platform account at each of a first list of operators;
identify a second list of operators;
gather individual sports gambling data from each of the second list of operators;
aggregate the individual sports gambling data from the second list of operators into aggregated sports gambling data;
display the aggregated sports gambling data to a user;
receive an input from the user,
wherein the input includes a target sport-related event, target odds, and a target monetary value;
automatically monitor odds offered by the second list of operators for the target sport-related event till a target time at which the target sports event takes place;
in response to that a target operator from the second list of operators offering odds at or exceeding the target odds:
automatically taking a first payment corresponding to the target monetary value from the user;
automatically place, via the platform account at the target operator, a bet on the target sport-related event of the target monetary value;
notify the user of the placement of the bet;
receive a result of the bet from the target operator;
notify the user of the result;
in response to that the user wins the bet:
receive a payback from the target operator;
send a second payment corresponding to an amount of the payback to the user;
in response to that no operator from the second list of operators has offered odds at
or exceeding the target odds till the target time:
notify the user of the non-placement of the bet.

2. The computerized system of claim 1, wherein the first payment is no less than the target monetary value.

3. The computerized system of claim 1, wherein the first payment equals the target monetary value.

4. The computerized system of claim 1, wherein the second payment is no larger than the amount of the payback.

5. The computerized system of claim 1, wherein the second payment equals the amount of the payback.

6. The computerized system of claim 1, wherein the individual sports gambling data includes a plurality of sport-related events and odds corresponding to each of the plurality of sport-related events.

7. The computerized system of claim 6, wherein for the aggregation of the individual sports gambling data, most favorable odds corresponding to each of the plurality of sport-related events is identified.

8. The computerized system of claim 7, wherein for the display of the aggregated sports gambling data, the most favorable odds corresponding to each of the plurality of sport-related events is highlighted.

9. The computerized system of claim 6, wherein the one or more hardware computer processors configured with computer-executable instructions that, when executed, further cause the one or more hardware computer processors to:
generate a prediction corresponding to each of the plurality of sport-related events.

10. The computerized system of claim 9, wherein the prediction includes a probability.

11. The computerized system of claim 9, wherein the prediction further includes a predictability.

12. The computerized system of claim 10, wherein the prediction is generated by a machine learning model trained with feature data,
wherein the feature data includes sport-related statistics.

13. The computerized system of claim 12, wherein the generation of a prediction corresponding to each of the plurality of sport-related events includes:
gathering the feature data;
feeding the feature data to the machine learning model;
obtaining the prediction generated by the machine learning model;
gathering an actual result of each of the plurality of the sport-related events;
saving the actual result of each of the plurality of the sport-related events with the feature data;
retraining the machine learning model on a batch basis with the actual result of each of the plurality of the sport-related events and the feature data.

14. The computerized system of claim 1, wherein the identification of the second list of operators includes:
identifying a state where a user locates in;
checking if sports gambling is legal in the state;
in response to that sports gambling is legal in the state:
identifying a second list of operators that are legally available in the state.

15. The computerized system of claim 14, wherein the identification of the second list of operators further includes:
in response to that sports gambling is not legalized in the state:
notifying the user.

16. The computerized system of claim 1, wherein the one or more hardware computer processors configured with computer-executable instructions that, when executed, further cause the one or more hardware computer processors to:
in response to that the target monetary value exceeds a first threshold:
send a warning to the user.

17. The computerized system of claim 16, wherein the first threshold is preset by the user.

18. The computerized system of claim 1, wherein the one or more hardware computer processors configured with computer-executable instructions that, when executed, further cause the one or more hardware computer processors to:
calculate a total amount of money the user spends on bets for a time period;
in response to that the total amount of money exceeds a second threshold;
send a warning to the user.

19. The computerized system of claim 18, wherein the second threshold is preset by the user.

20. The computerized system of claim 19, wherein the time period is preset by the user.
